(19) United States
(12) Patent Application Publication
(10) Pub. No.: US 2016/0032874 A1
(43) Pub. Date: Feb. 4, 2016

(54) DIESEL PARTICULATE FILTER (DPF)

(71) Applicant: HYUNDAI MOTOR COMPANY, Seoul (KR)

(72) Inventor: Sung Mu CHOI, Seongnam-si (KR)

(73) Assignee: HYUNDAI MOTOR COMPANY

(21) Appl. No.: 14/569,370

(22) Filed: Dec. 12, 2014

(30) Foreign Application Priority Data
Jul. 29, 2014 (KR) 10-2014-0096242

(51) Int. Cl. F02M 35/02; F02M 35/024

(52) U.S. Cl. CPC F02M 35/0201; F02M 35/024

(57) ABSTRACT

A diesel particulate filter includes a carrier in which facing sides of a plurality of filter walls are spaced apart from each other form an exhaust gas inlet channel and an exhaust gas outlet channel, and a plurality of plugs are disposed to block a back end of the exhaust gas inlet channel and a front end of the exhaust gas outlet channel. A porosity or a pore size of the filter walls in a front part of the carrier is different from a porosity or a pore size of the filter walls in a back part of the carrier. The front part and the back part of the carrier are divided based on a longitudinal direction of the exhaust gas inlet channel, to prevent soot trapped in the carrier from being concentrated in a back-end part of the diesel particulate filter.

### CROSS-REFERENCE TO RELATED APPLICATION

This application claims under 35 U.S.C. §119(a) the benefit of priority to Korean Patent Application No. 10-2014-0096242 filed on Jul. 29, 2014, the entire contents of which are incorporated herein by reference.

### TECHNICAL FIELD

The present disclosure relates to a diesel particulate filter (DPF), and more particularly, relates to a DPF with improved durability, thereby preventing a crack or melting from occurring at a part that is exposed to a high temperature.

### BACKGROUND

Exhaust gas is emitted in the air through an exhaust pipe when a gas mixture is combusted in a combustion chamber of an internal combustion engine. The exhaust gas contains noxious materials, such as carbon monoxide (CO), nitrogen oxides (NOx), and imperfect combustion hydrocarbon (HC).

Diesel engine vehicles emit the exhaust gas containing significantly more nitride oxides and particulates than gasoline engine vehicles although they have high fuel efficiency and high power.

In order to reduce the particulates included in the exhaust gas, a diesel particulate filter (DPF) is widely used.

The DPF is installed on an exhaust line to trap non-flammable diesel particulates (that is, soot) emitted from the engine. The DPF repeatedly raises its internal temperature to an ignition temperature or more to burn and regenerate the particulates.

In a carrier of the DPF, a plug of each exhaust gas inlet channel is alternately arranged with a plug of each exhaust gas outlet channel to gather soot of particulates when exhaust gas passes through fine pores formed in filter walls. When the trapped mass of soot gathered in the DPF reaches a predetermined amount or more as time elapses, the DPF raises the internal temperature to the ignition temperature or more to eliminate the soot.

FIG. 1 is a cross-sectional view of a DPF. As shown in FIG. 1, a carrier 11 of a DPF 10 includes a plurality of filter walls 12 spaced a predetermined distance apart from each other, wherein the facing sides of the plurality of filter walls 12 form an exhaust gas inlet channel 13 and an exhaust gas outlet channel 14 so that the inlet channel 13 and the outlet channel 14 are alternately arranged.

A plurality of plugs 15 are installed to block a back end of each inlet channel 13 and the front end of each outlet channel 14 so that the front end of the inlet channel 13 opens with the back end blocked by the plug 15, and the back end of the outlet channel 14 opens with the front end blocked by the plug 15.

The DPF 10 is exposed to a high temperature when it traps the particulates emitted from the engine and then regenerates the particulates at a high temperature, and at this time, a crack or melting may occur in the filter walls 12 due to exposure to the high temperature. In this case, the DPF 10 may lose its own function.

Also, a part in which a crack or melting is easy to occur due to exposure to a high temperature is a part that is opposite to a part at which the exhaust gas enters the DPF 10, that is, the back-end part of the DPF 10. As shown in FIG. 1, more soot is deposited toward the back-end part of the DPF 10 in the inlet channel 13 of the DPF 10.

As a result, if the back-end part of the DPF 10 is exposed to a high temperature due to rapid combustion when soot is combusted by post injection, a crack or melting may occur in the part exposed to the high temperature.

The above information disclosed in this Background section is only for enhancement of understanding of the background of the disclosure, and therefore, it may contain information that does not form the prior art that is already known in this country to a person of ordinary skill in the art.

### SUMMARY OF THE DISCLOSURE

The present disclosure has been made in an effort to solve the above-described problems associated with prior art.

In one aspect, the present disclosure provides a diesel particulate filter (DPF) with improved durability, which is capable of preventing soot trapped in a carrier of the DPF from being concentrated in the back-end part of the DPF to prevent an excessive temperature rise in a back-end part of the DPF, thereby preventing a crack or melting from occurring at a part that is exposed to a high temperature.

In an exemplary embodiment, a diesel particulate filter comprises a carrier in which facing sides of a plurality of filter walls are spaced apart from each other and form an exhaust gas inlet channel and an exhaust gas outlet channel. A plurality of plugs are provided to block a back end of the exhaust gas inlet channel and a front end of the exhaust gas outlet channel. A porosity or a pore size of the filter walls in a front part of the carrier is different from a porosity or a pore size of the filter walls in a back part of the carrier. The front part and the back part of the carrier divided based on a longitudinal direction of the exhaust gas inlet channel to prevent a soot trapped in the carrier from being concentrated in a back-end part of the diesel particulate filter.

The porosity or the pore size of the filter walls in the front part of the carrier may be greater than the porosity or the pore size of the filter walls in the back part of the carrier.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure.

FIG. 1 is a cross-sectional view of a diesel particulate filter (DPF) according to the related art.

FIG. 2 is a cross-sectional view of a diesel particulate filter (DPF) according to an embodiment of the present inventive concept.

FIG. 3 is a graph showing the thicknesses of gathered soot with respect to longitudinal locations in the DPF according to the related art and the DPF according to an embodiment of the present inventive concept.

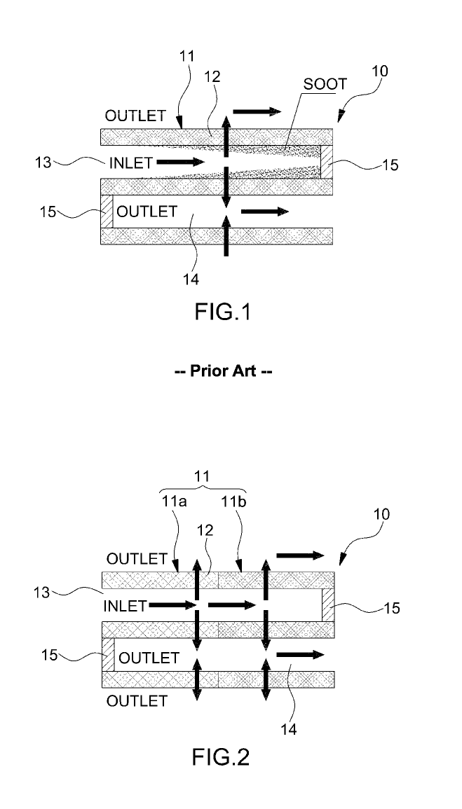

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the inventive concept to those exemplary embodiments. On the contrary, the inventive concept is intended to cover not only the exemplary embodiments, but also various alternatives, modifications, equivalents, and other embodiments, which may be included within the spirit and scope of the inventive concept as defined by the appended claims.

The present disclosure provides a diesel particulate filter (DPF) with improved durability, which is capable of preventing soot trapped in a carrier of the DPF from being concentrated in the back-end part of the DPF to avoid an excessive temperature rise in the back-end part of the DPF, thereby preventing a crack or melting from occurring at a part that is exposed to a high temperature.

FIG. 2 is a cross-sectional view of a DPF according to an embodiment of the present disclosure. Referring to FIG. 2, a carrier 11 of a DPF 10 may include a plurality of filter walls 12 spaced apart from each other in a predetermined distance.

The facing sides of the plurality of filter walls 12 may form an exhaust gas inlet channel 13 and an exhaust gas outlet channel 14 so that the inlet channel 13 and the outlet channel 14 are alternately arranged.

In the carrier 11 of the DPF 10, a plug 15 of each inlet channel 13 may be alternately arranged with the plug 15 of each outlet channel 14 so as to trap soot of particulates when exhaust gas passes through fine pores (air pores) formed in the filter walls 12.

That is, a plurality of plugs 15 may be installed to block a back end of each inlet channel 13 and the front end of each outlet channel 14 such that the front end of the inlet channel 13 opens with the back end blocked by the plug 15, and the back end of the outlet channel 14 opens with the front end blocked by the plug 15.

According to the embodiment of the present inventive concept, in order to prevent soot trapped in the carrier 11 from being concentrated in the back-end part of the DPF 10, the filter walls 12 in the front part 11a of the carrier 11 and the filter walls 12 in the back part 11b of the carrier 11 have different porosities and different pore sizes, wherein the front part 11a and the back part 11b of the carrier 11 are divided based on a longitudinal direction of the inlet channel 13.

More specifically, the filter walls 12 in the front part 11a of the carrier 11 may have a greater porosity or a greater pore size than that of the filter walls 12 in the back part 11b of the carrier 11.

The front part 11a of the carrier 11 is a part at which the exhaust gas enters the DPF 10, and the back part 11b of the carrier 11 is a part at which the exhaust gas is discharged from the DPF 10, based on a direction in which exhaust gas passes through the DPF 10.

As such, by differentiating the porosity or pore size of the filter walls 12 in the front part 11a of the carrier 11 from that of the filter walls 12 in the back part 11b of the carrier 11 wherein the front part 11a and the back part 11b of the carrier 11 are divided based on the longitudinal direction of the inlet channel 13, it is possible to reduce differences between trapped masses of soot at different locations in the longitudinal direction of the inlet channel 13.

Particularly, by making the porosity or pore size of the filter walls 12 in the front part 11a greater than that of the filter walls 12 in the back part 11b, the front part 11a of the carrier 11 may pass more amount of exhaust gas therethrough than the back part 11b of the carrier 11 so as to allow more exhaust gas to flow than the back part 11b of the carrier 11. As a result, the soot can be uniformly trapped throughout the entire area of the DPF 10 in a longitudinal direction.

In the related art, there is a problem that soot is concentrated in the back-end part (a part that is opposite to a part at which exhaust gas enters a filter) of a carrier (since the carrier has a constant porosity or a constant pore size). However, according to the embodiment of the present inventive concept, by allowing a more flow of exhaust gas through the front part 11a of the carrier 11 than through the back part 11b of the carrier 11, a trapped mass of soot can be uniformly distributed throughout the entire area of the DPF 10 in the longitudinal direction.

Thereby, the problem of the related art that soot is concentrated in the back-end part of a carrier can be overcome, and accordingly, an excessive temperature rise at the back-end part of the filter can be prevented.

According to an embodiment, the DPF 10 may be configured by bonding heterogeneous carriers having different porosities and different pore sizes, which are to constitute the front part 11a and the back part 11b, respectively. In this case, the carrier to constitute the front part 11a may be made of a substance having a great porosity or a great pore size, and the carrier to constitute the back part 11b may be made of a substance having a relatively small porosity or a relatively small pore size. By aligning the heterogeneous carriers and bonding the filter walls of the carriers using a bonding material such as cement, a carrier that is used in a filter may be fabricated.

As such, by differentiating the porosity or pore size of the filter walls 12 in the front part 11a of the carrier 11 from that of the filter walls 12 in the back part 11b of the carrier 11 wherein the front part 11a and the back part 11b are divided based on the longitudinal direction of the inlet channel 13, it is possible to trap uniform mass of soot throughout the entire area of the DPF 10 in the longitudinal direction of the inlet channel 13.

Particularly, by making the porosity or pore size of the filter walls 12 in the front part 11a of the carrier 11 greater than that of the filter walls 12 in the back part 11b of the carrier 11 to increase the flow of exhaust gas in the front part 11a, more soot can be gathered in the front part 11a compared to the DPF according to the related art.

As a result, soot can be uniformly distributed and gathered throughout the entire area of the DPF 10 in the longitudinal direction of the inlet channel 13, without being concentrated in the back-end part of the DPF 10, thereby preventing an excessive temperature rise in the back-end part of the DPF 10.

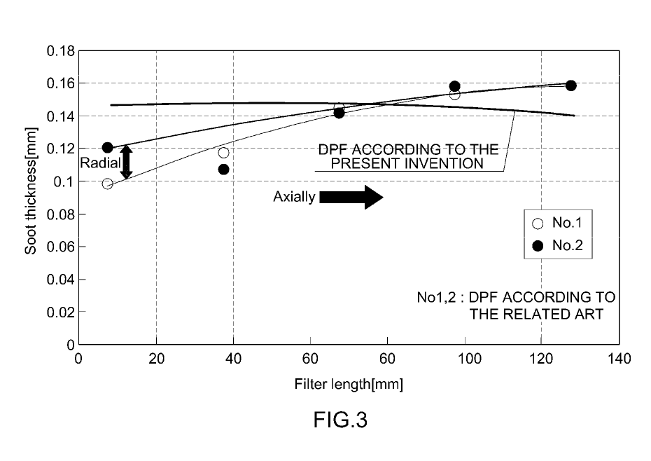

FIG. 3 is a graph showing the thicknesses of gathered soot with respect to longitudinal locations in the DPF according to the related art and the DPF 10 according to an embodiment of the present inventive concept. FIG. 3 shows that the

DPF 10 according to the embodiment of the present disclosure achieves a uniform distribution of soot in the longitudinal direction compared to the DPF according to the related art.

As a result, the back part 11b of the DPF 10 can be prevented from being excessively exposed to a high temperature so as to improve the durability of the DPF 10, and a Mass Soot Limit (MSL) can increase to achieve high fuel efficiency and to prevent excessive oil dilution of the DPF 10.

The MSL is a limit value of soot trapping for post injection, and when trapped soot reaches the MSL, the DPF 10 is regenerated through post injection.

What is claimed is:

1. A diesel particulate filter comprising:
a carrier including:
facing sides of a plurality of filter walls spaced apart from each other, and forming an exhaust gas inlet channel and an exhaust gas outlet channel; and
a plurality of plugs provided to block a back end of the exhaust gas inlet channel and a front end of the exhaust gas outlet channel,
wherein a porosity or a pore size of the filter walls in a front part of the carrier is different from a porosity or a pore size of the filter walls in a back part of the carrier, and
the front part and the back part of the carrier are divided based on a longitudinal direction of the exhaust gas inlet channel to prevent a soot trapped in the carrier from being concentrated in a back-end part of the diesel particulate filter.

2. The diesel particulate filter of claim 1, wherein the porosity or the pore size of the filter walls in the front part of the carrier is greater than the porosity or the pore size of the filter walls in the back part of the carrier.

3. The diesel particulate filter of claim 1, wherein the inlet channel and the outlet channel are alternately arranged.
